(19) United States
(12) Patent Application Publication
(10) Pub. No.: US 2026/0160621 A1
(43) Pub. Date: Jun. 11, 2026

(54) System and Method to Makeup and Evaluate Tubular Connections Based on Artificial Intelligence Analysis of Graphical Representations

(71) Applicant: Weatherford Technology Holdings, LLC, Houston, TX (US)

(72) Inventors: Benjamin Sachtleben, Hannover (DE); Rainer Rühmann, Hannover (DE); David Geissler, Hannover (DE); Andreas Brüning, Burgwedel (DE)

(21) Appl. No.: 19/040,157

(22) Filed: Jan. 29, 2025

Related U.S. Application Data
(60) Provisional application No. 63/729,956, filed on Dec. 10, 2024.

(51) Int. Cl. G01L 5/24; G05B 13/02; G06N 3/0464

(52) U.S. Cl. CPC G01L 5/24; G05B 13/027; G06N 3/0464

(57) ABSTRACT

In running tubulars, threaded tubular connections are made up by applying torque in rotating one tubular in turns with connection equipment relative to another tubular. Equipment sensors measure data during the makeup of the threaded connections, and a computer system processes the data to generate graphical representations of the processed data. The system receives user-indicated assessments of the threaded connections indicating whether a connection error of a failed makeup has occurred. An artificial intelligence model implemented on the system is trained with the graphical representations based on the user-indicated assessments. In subsequent connections, the trained model analyzes the graphical representations for the connection error and provides outputs accepting and rejecting the threaded connections.

### CROSS-REFERENCE TO RELATED APPLICATIONS

This application claims the benefit of U.S. Provisional Appl. No. 63/729,956 filed Dec. 10, 2024, which is incorporated herein by reference in its entirety.

### BACKGROUND OF THE DISCLOSURE

Long tubular strings are used for casing, risers, drillstring, completion strings, or other tubing strings in oil or gas wells. Due to their length, these strings are made up of sections or stands of tubulars that are progressively added to or removed from the tubular strings as the tubular string are lowered or raised from a drilling platform.

To construct the tubular strings, tubulars are connected by fluid-tight threaded joints, which have a connection threaded together to a target torque. A tong assembly is commonly used to make up or break out the joints between the tubulars in the tubular string. During makeup the joint between tubulars, the tong assembly holds one tubular stationery and rotates the other tubular until a target torque is reached for the threaded connection.

Several approaches are used to make up the joint to a target torque. For example, an operator can manually control the tong assembly. During makeup, the tong assembly rotates one tubular of the joint, while the other tubular is held stationery. A dump valve is then used to stop the rotation when a target torque is reached. Depending on parameters of the tubulars, this manual control may lead to over torque of the threaded connection, when the rotational speed of the tong assembly is too high at a final stage of making up the joint.

In another approach, the tong assembly can use a closed-loop control of torque or rotational speed during makeup to achieve the target torque. Depending on the set speed, the closed-loop control may take a long time to make up each joint. As an alternative, the control of the tong assembly can rotate the tubular for a predetermined time at a constant speed to achieve the target torque. The predetermined time is obtained from heuristically measured values, which are results of particular parameters, such as the reactions time of the tong assembly to a specific type of tubulars and the speed of the tong assembly.

After the joint is made up, the threaded connection is typically evaluated before carrying any loads and being run into the well. Current systems rely on predefined algorithms to evaluate the quality of threaded connections. For example, to accept or reject a threaded connection, these predefined algorithms make manual or semi-automated assessments of torque, turn, and time data obtained during makeup of the threaded connection. Unfortunately, the initial evaluation based on these measurements can diagnose false connection failures. Therefore, a human operator has to perform further examination to reach a final decision whether to accept or reject the threaded connection. Therefore, there is a need for improved methods for making up and evaluating threaded connections of tubulars.

The subject matter of the present disclosure is directed to overcoming, or at least reducing the effects of, one or more of the problems set forth above.

### SUMMARY OF THE DISCLOSURE

In one configuration of the present disclosure, a method is used in running tubulars. The method comprises: making up a threaded connection of the tubulars by applying torque in rotating at least one of the tubulars in turns with connection equipment relative to another of the tubulars; measuring, with sensors associated with the connection equipment, data as measured data during makeup of the threaded connection; processing, with a control system, the measured data as processed data; generating, with the control system, a graphical representation of the processed data; analyzing, in analysis with an artificial intelligence model implemented on the control system, the graphical representation for at least one connection error indicative of a failed makeup of the threaded connection; and providing, with the control system, an output accepting or rejecting the threaded connection based on the analysis.

In the method, analyzing in the analysis with the artificial intelligence model implemented in the computing environment can comprise analyzing with the artificial intelligence model implemented on one or more of: the control system, a remote system, and a cloud-based system in the computing environment.

In the method, measuring the data can comprise measuring torque values applied to the threaded connection and turns values of the at least one tubular being rotated, processing the measured data can comprise evaluating the torque values relative to the turns values, and generating the graphical representation of the processed data can comprise graphing a torque-turns curve of the torque values relative to the turns values.

To analyze the graphical representation for the at least one connection error in the analysis with the artificial intelligence model, the method can comprise: analyzing the torque-turn curve for the turns values relative to a minimum turns threshold; analyzing the torque-turn curve for the torque values relative to a minimum torque threshold; and determining, based on the analysis of the torque-turns curve, a lack of connection being indicative of the at least one connection error.

To analyze the graphical representation for the at least one connection error in the analysis with the artificial intelligence model, the method can comprise: analyzing the torque-turns curve for the torque values relative to a maximum torque threshold; and determining, based on the analysis of the torque-turns curve, a torque spike being indicative of the at least one connection error.

To analyze the graphical representation for the at least one connection error in the analysis with the artificial intelligence model, the method can comprise determining, based on the analysis of the torque-turns curve, a torque drop being indicative of the at least one connection error.

To analyze the graphical representation for the at least one connection error in the analysis with the artificial intelligence model, the method can comprise: analyzing the torque-turns curve for an indicated pattern; and determining, based on the indicated pattern, an issue associated with at least one of the connection equipment and the threaded connection as the at least one connection error.

For example, analyzing the torque-turns curve for the indicated pattern can comprise analyzing the torque-turns curve for at least one of: an irregular pattern, a repeating pattern, and an oscillating pattern; and determining the issue can comprise determining at least one of: an issue with misalignment between the tubulars, an issue with threading in the threaded connection, an issue with mechanics of the connection equipment, an issue with a gear in the connection equipment, an issue with hydraulics of the connection equipment, and an issue with disruptive movement of the connection equipment.

To analyze the graphical representation for the at least one connection error in the analysis with the artificial intelligence model, the method can comprise: receiving a manual indication of a shouldering point in the threaded connection; evaluating the manual indication based on the analysis of the graphical representation with the artificial intelligence model; and determining, based on the evaluation of the manual indication, improper shouldering within the threaded connection as the at least one connection error.

To analyze the graphical representation for the at least one connection error in the analysis with the artificial intelligence model, the method can comprise: analyzing the torque-turns curve; and determining a shouldering point in the threaded connection based on the analysis. For example, providing the output comprises returning an indication of the shouldering point.

The method can further comprise determining improper shouldering within the threaded connection; and wherein providing the output comprises returning an indication of the improper shouldering as the at least one connection error. Likewise, determining the improper shouldering can comprise determining a deviation, a hump, a drop, a low shouldering point, a high shouldering point, or an irregular shape in the torque-turns curve.

In the method, measuring the data can comprise measuring time values and measuring torque values; processing the measured data can comprise evaluating the torque values over the time values; generating, with the control system, the graphical representation of the processed data can comprise incorporating the torque values over the time values in the graphical representation; and analyzing the graphical representation can comprise determining a decrease in the torque values over the time values being indicative of the at least one connection error.

In the method, measuring the data can comprise measuring torque values and measuring turns values; processing the measured data can comprise evaluating slope as the torque values per turn relative to the turns values; generating, with the control system, the graphical representation of the processed data can comprise incorporating the slope relative to the turns values in the graphical representation; and analyzing the graphical representation can comprise determining the at least one connection error based on the slope relative to the turns values.

In the method, providing the output can comprise providing at least one of: a visual alarm to an operator, an audible alarm to the operator, a graphical user interface to the operator, and an automated control to the connection equipment to break the threaded connection.

In one arrangement of the method, analyzing the graphical representation for the at least one connection error in the analysis with the artificial intelligence model can comprise: implementing the artificial intelligence model including a large language model trained by a dataset of training graphical representations; and analyzing graphical data in the graphical representation directly with the large language model for the at least one connection error.

In another arrangement of the method, analyzing the graphical representation for the at least one connection error in the analysis with the artificial intelligence model can comprise: implementing the artificial intelligence model including a large language model trained by a dataset of training graphical representations; converting graphical data in the graphical representation input into the large language model into an output of descriptive text; and analyzing the descriptive text with the artificial intelligence model or keyword search for the at least one connection error.

In another arrangement of the method, analyzing the graphical representation for the at least one connection error in the analysis with the artificial intelligence model can comprise: implementing the artificial intelligence model including a convolutional neural network trained by a dataset of training graphical representations; and analyzing graphical data in the graphical representation directly with the convolutional neural network for the at least one connection error.

In another configuration of the present disclosure, a method is used in running tubulars. The method comprises: making up threaded connections of the tubulars by applying torque in rotating at least one of the tubulars in turns with connection equipment relative to another of the tubulars; measuring, with sensors associated with the connection equipment, data as measured data during makeup of the threaded connections; processing, with a control system, the measured data as processed data; generating, with the control system, graphical representations of the processed data; receiving, with the control system, assessments of initial ones of the threaded connections, the assessments being user-indicated and being based on at least one connection error indicative of a failed makeup; training an artificial intelligence model implemented on the control system with the graphical representations based on the assessments; analyzing, in an analysis with the trained artificial intelligence model implemented on the control system, subsequent ones of the graphical representations for the at least one connection error; and providing, with the control system, outputs indicative of the subsequent threaded connections based on the analysis.

The method can further comprise: receiving, with the control system, choices of the outputs, the choices being user-indicated and confirming and declining the acceptance and the rejections of the subsequent threaded connections; and training the artificial intelligence model implemented on the control system with the graphical representations based on the choices.

In yet another configuration of the present disclosure, a system is used in running tubulars. The system comprises connection equipment, sensors, and a control system. The connection equipment is operable to apply torque to rotate at least one of the tubulars in turns relative to the other of the tubulars during makeup of a threaded connection. The sensors are associated with the connection equipment and are configured to measure data as measured during the makeup of the threaded connection. The control system is operably connected to the connection equipment and is in communication with the sensors. The control system is configured to perform a method according to any one of clauses 1 to 17.

For example, The control system can be configured to: process the measured data as processed data; generate a graphical representation of the processed data; analyze, in an analysis with an artificial intelligence model implemented on the control system, the graphical representation for at least one connection error indicative of a failed makeup of the threaded connection; and provide an output accepting or rejecting the threaded connection based on the analysis.

In the system, the sensors can comprise: a torque cell being configured to measure the torque applied to the threaded connection; a turns counter being configured to measure the turns of the at least one tubular being rotated; and a timer being configured to measure time.

In the system, the connection equipment can comprise a tong assembly having a power tong and a backup tong, the power tong being configured to engage and rotate a first of the tubulars, the backup tong being configured to engage and hold a second of the tubulars stationery.

In the system, the control system can comprise: a programmable logic controller in communication with the connection equipment and the sensors and including a program to automatically make up the threaded connection; and a computer in communication with the programmable logic controller and having a program to automatically analyze the threaded connection.

The foregoing summary is not intended to summarize each potential embodiment or every aspect of the present disclosure.

### BRIEF DESCRIPTION OF DRAWINGS

FIG. 1A illustrates connection equipment used with a system to makeup, evaluate, and analyze a threaded connection of tubulars according to the present disclosure.

FIGS. 1B-1C illustrate cross-sectional views of different configurations for threaded connections between tubulars according to the present disclosure.

FIG. 2 schematically illustrates the connection equipment and the system of FIG. 1A.

FIG. 3A illustrates a process of integrating the disclosed system into making up threaded connections for tubulars.

FIG. 3B illustrates a process of making up and evaluating threaded connections of tubulars according to the present disclosure.

FIG. 4A illustrates an example of a graphical representation of the present disclosure for use by the disclosed system.

FIG. 4B illustrates an example of a graphical representation of the present disclosure for use in training the artificial intelligence model of the disclosed system.

FIG. 4C illustrates another example of a graphical representation of the present disclosure for use in training the artificial intelligence model of the disclosed system.

FIG. 4D illustrates yet another example of a graphical representation of the present disclosure for use in training the artificial intelligence model of the disclosed system.

FIG. 4E illustrates yet another example of a graphical representation of the present disclosure for use in training the artificial intelligence model of the disclosed system.

FIG. 5 schematically illustrates a natural language processing platform for automated training and performance evaluation by the disclosed system.

FIG. 6 schematically illustrates a convolutional neural network used for analysis by the disclosed system.

FIG. 7 schematically illustrates a framework to train a neural network for the analysis of the disclosed system.

### DETAILED DESCRIPTION OF THE DISCLOSURE

Systems and methods are disclosed for automated makeup and evaluation of tubular connections in a drilling operation. Graphical representations of the makeup and evaluations of the tubular connections are analyzed using an artificial intelligence model.

### A. Connection Equipment and Control System

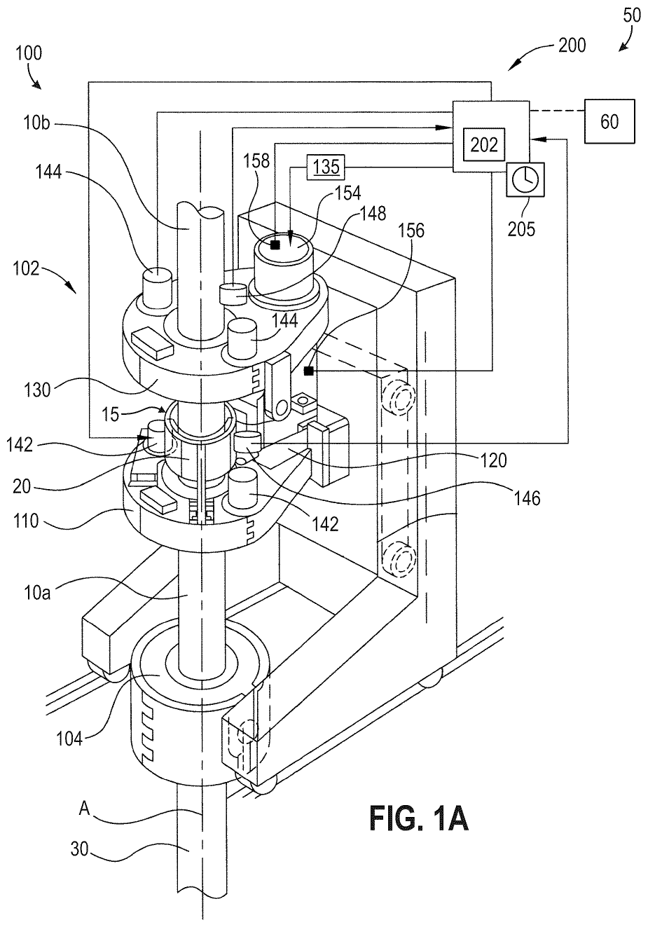

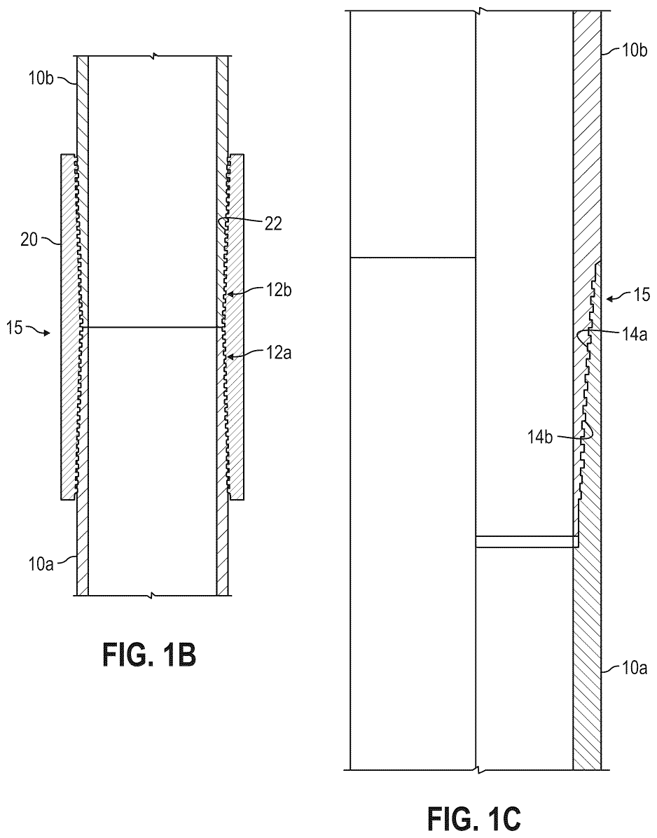

FIG. 1A is a schematic perspective view of a control system 200 according to the present disclosure to makeup, evaluate, and analyze threaded connections of tubulars using connection equipment 100 during tubular running. The connection equipment 100 includes a tong assembly 102 and a spider 104, and the control system 200 includes a controller 202 for controlling the tong assembly 102 during a makeup process and for evaluating threaded connections.

The tong assembly 102 includes a power tong 130 and a backup tong 110 and can be operated according to an automated makeup process, such as disclosed in U.S. Pat. No. 10,808,42, which is incorporated herein by reference. During operation, the tong assembly 102 is placed on a drilling rig coaxially with a central axis A of a tubing string 30. The tong assembly 102 is positioned above the spider 104 on a drilling rig so a new tubular 10b can be added in a tubular connection 15 to a lower tubular 10a of the tubing string 30 while the tubing string 30 rests in the spider 104. (As will be appreciated, the tong assembly 102 can also be used to remove the upper tubular 10b from the tubing string 30 while the tubing string 30 rests in the spider 104.)

Different types of threaded connections 15 can be made up between the tubulars 10a-b. FIGS. 1B-1C illustrate two configurations of threaded connections 15, but others are possible for the purposes of the present disclosure. The threaded connection 15 in FIG. 1B shows a lower tubular 10a having a coupling 20 that is pre-made on a “mill end” of the lower tubular 10a. In particular, internal thread inside the bore 22 of the coupling 20 is first threaded onto a pin end 12a of the lower tubular. To make up the connection 15, the threaded pin 12b on a “field end” of the upper tubular 10b is threaded into the coupling 20.

The threaded connection 15 in FIG. 1C shows a flush joint. The lower tubular 10a has a female end 14a with internal thread, and the upper tubular 10b has a male end 14b with external thread. The male end 14b of the upper tubular 10b is threaded to the female end 14a of the lower tubular 10a to make up the connection. Each tubular 10a-b would have male and female ends 14a-b, which can be joined together to create a tubing string during installation in a well. Other types of joints, such as a semi-flush joint, can be used.

During operation of the tong assembly 102 in FIG. 1A, a “field end” of the upper tubular 10b is aligned and initially set in the “mill end” of the lower tubular 10a. As noted above and shown here, the field end of the upper tubular 10b can have a threaded pin that threads into a coupling 20 already threaded onto the lower tubular 10a to make up the threaded connection 15 of the tubulars 10a-b. (As an alternative noted above, the upper tubular 10b can have a male threaded end that can thread into a female threaded end of the lower tubular 10a.)

The power tong 130 receives and clamps to the upper tubular 10b, while the backup tong 110 receives and clamps to the lower tubular 10a on top of the tubing string 30. For example, the backup tong 110 can clamp to the lower tubular 10a below the coupling 20. The power tong 130 rotates the upper tubular 10b while the backup tong 110 holds the lower tubular 10a stationery, causing relative rotation between the tubulars 10a-b and thereby making up the threaded connection between the tubulars 10a-b. (As noted previously, the tong assembly 102 can break out the threaded connection between the tubulars 10a-b depending of the direction of rotation.)

The power tong 130 and the backup tong 110 may be coupled together by a frame 120. Typically, the power tong 130 includes a side door to receive or release the upper tubular 10b, and the side door can close to clamp the upper tubular 10b in the power tong 130. Similarly, the backup tong 110 may include a side door, which may open to receive or release the lower tubular 10a and may close to clamp the lower tubular 10a in the backup tong 110.

One or more actuators 144 may be used to drive gripping pads in the power tong 130 to clamp the upper tubular 10b during operation. Also, one or more actuators 142 may be used to drive gripping pads in the backup tong 110 to clamp the lower tubular 10a and hold the lower tubular 10a stationery during operation. The actuators 142, 144 may be hydraulic actuators, mechanical actuators, or other suitable actuators.

The actuators 142, 144 are connected to the controller 202 and may receive commands from the controller 202 to clamp, release, or adjust clamping force exerted against the tubulars 10a-b. The controller 202 may also be connected to other actuators, such as the actuators 142, 144 through a drive unit, such as a hydraulic power unit when the actuators are hydraulic actuators.

The power tong 130 may include a drive unit 135 configured to drive a motor assembly 154, which is configured to rotate the upper tubular 10b clamped in the power tong 130. In general, the motor assembly 154 may include a drive motor and a gear assembly. The motor assembly 154 may include a hydraulic motor assembly or an electric motor assembly. For example, the drive unit 135 may be a hydraulic drive circuit configured to drive a hydraulic motor of the motor assembly 154. As further shown, the motor assembly 154 and the drive unit 135 are connected to the controller 202c. The motor assembly 154 may receive commands from the controller 202 to rotate forward, backward, and at a target speed.

The tong assembly 102 includes sensors 140 to measure data during operations. For example, the sensors 140 can include a turns counter 158 connected to the controller 202 to monitor the rotation of the power tong 130. The turns counter 158 may be an internal turns counter, such as a decoder connected to a drive shaft inside a gear box of the power tong 130. Therefore, the turns counter 158 connected to the controller 202 can be used to measure turns of the upper tubular 10b clamped in the power tong 130 during operation.

The sensors 140 can include a turns sensor 148, which is mounted on the power tong 130 and is configured to measure turns of the upper tubular 10b clamped in the power tong 130. Connected to the controller 202, the turns sensor 148 can send measurements to the controller 202. Measurements of the turns sensor 148 may be used to generate commands for rotational speed in a closed loop control during an automated makeup process according to the present disclosure. Measurements of the turns sensor 148 may also be used to evaluate the threaded connection during an automated evaluation process according to the present disclosure. As will be appreciated, the turns sensor 148 may be any sensor capable of measuring rotation. For example, the turns sensor 148 may be contactless turns counter, such as an optical sensor or a laser sensor. Alternatively, the turns sensor 148 may be configured to contact a surface to be measured for rotation. For example, the turns sensor 148 may be a friction wheel sensor.

The sensors 140 can also include a turns sensor 146, which can be mounted on the backup tong 110 can be configured to measure rotation of the upper tubular 10b clamped in the backup tong 110. The turns sensor 146 may be positioned to measure rotation of the upper tubular 10b or the coupling 20 relative to the backup tong 110. Measurements of this other turns sensor 146 may be used to detect backup slippage and/or coupling rotation during an automated makeup process according to the present disclosure. Measurements of the turns sensor 146 may also be used to evaluate the threaded connection during an automated evaluation process according to the present disclosure. The turns sensor 146 may be any sensor capable of measuring rotation. For example, the turns sensor 146 may be contactless turns counter, such as an optical sensor or a laser sensor. Alternatively, the turns sensor 146 may be configured to contact a surface to be measured for rotation. For example, the turns sensor 146 may be a friction wheel sensor.

The sensors 140 can also include one or more load cells 156 positioned to measure the torque applied to the tubulars 10a-b of the threaded connection being made up or broken out by the tong assembly 102. For example, the load cell 156 may be disposed in a torque load path between the power tong 130 and the backup tong 110. Alternatively, the load cell 156 may be positioned to measure a displacement of the tong assembly 102. In turn, the measured displacement may be used to calculate the torque between the tubulars 10a-b in the tong assembly 102. During an automated makeup process according to the present disclosure, measurements of the load cell 156 may be used to generate rotation command to the power tong 130. Likewise, measurements of load cell 156 may also be used to evaluate the threaded connection during an automated evaluation process according to the present disclosure.

The controller 202 is connected to the tong assembly 102 and may include hardware and software for performing automated makeup operations and automated evaluation operations. The control system 200 and the controller 202 may include various hardware, such as processors, programmable logic controllers (PLCs), one or more computers, and one or more mobile devices. Hardware of the controller 202 may be positioned together or at separate locations. For example, the controller 202 may include a PLC that is positioned in-situ with the tong assembly 102 for performing an automated makeup process. The control system 200 may include a computer for performing an automated processes and may include one or more mobile devices that are located at remote locations. Communications between the control assembly 200, the controller 202, and the tong assembly 102 may include wired and wireless communication. Computing and communications as disclosed herein may also be implemented in a computing environment 50, which can include the control system 200 and a remote system 60, such as a cloud-based system.

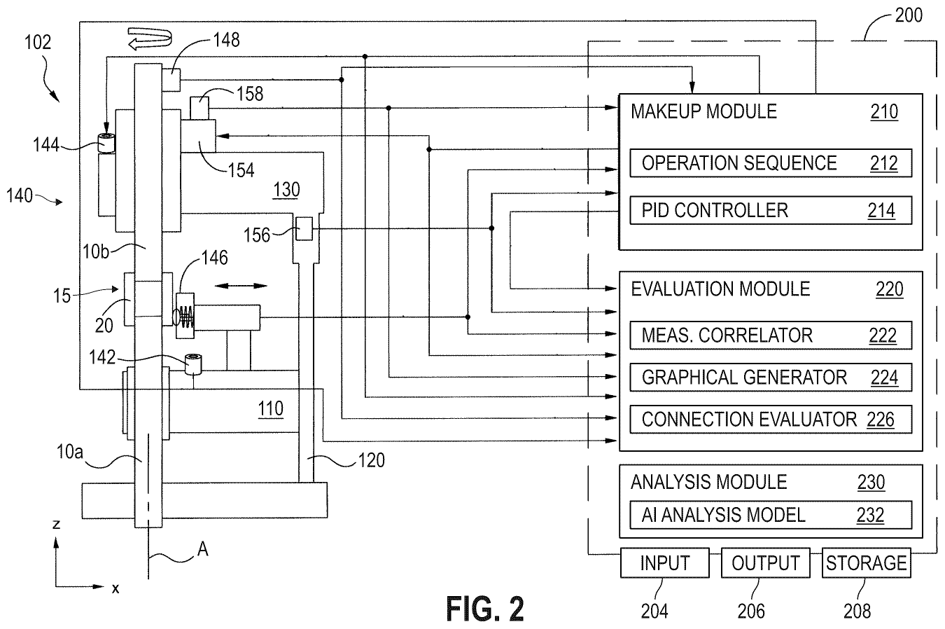

FIG. 2 schematically illustrates features of the tong assembly 102 and the control system 200. The tong assembly 102 and the control system 200 are shown connected by various data connections so the two can achieve a combined automated makeup process and automated evaluation process. The data connections may be wired connections, wireless connections, or virtual connections achieved by data sharing according to the function of the connection.

As discussed above, the control system 200 includes a combination of hardware components and software programs configured to perform an automated makeup process and automated evaluation process. Even though the control system 200 is shown as one block in FIG. 2, hardware, and software components in the control system 200 may be integrated together or distributed in multiple locations.

The control system 200 includes an automated makeup module 210, an automated evaluation module 220, and an automated analysis module 230. As indicated, each of these modules 210, 220, 230 can be automated in their operation, requiring little to no user intervention. The control system 200 may also include one or more input devices 204, one or more output devices 206, and a storage device 208.

The input device 204 may include keyboards, mice, push buttons, microphones, joysticks, or other user interface components. The input device 204 is configured to receive tubular information, system configuration, commands from human operators, or other information related to the automated makeup process and the automated evaluation process according to the present disclosure. In some embodiments, predetermined values, such as an optimum torque value, a dump torque value, and a minimum and maximum torque value, may be input through the input device 204 prior to making a threaded connection.

The output devices 206 may include monitors, printers, speakers, or other user interface components. The output device 206 may be used to provide operating details to human operators. For example, during an automated makeup process, a technician may observe the operating details on an output device 206, such as a video monitor or display. An operator may observe the various predefined values which have been input for a particular connection. Further, the operation may observe graphical information, such as the torque rate curve and the torque rate differential curve, in a graphical user interface on an output device 206.

The storage device 208 may be a hard drive or solid-state drive that is connected to hardware components of the control system 200. Alternatively, the storage device 208 may be located in the cloud for recording makeup data, tubular information, and other data related to an operation. The stored data may then be used to generate a post makeup report.

As discussed below, information related to the automated makeup process is used in the automated evaluation process to correct measurement data, remove false failure information, therefore, improve efficiency of the entire process.

As noted, the makeup module 210 can perform an automated makeup process, such as disclosed in incorporated U.S. Pat. No. 10,808,472. For example, the automated makeup module 210 sends out commands to the motor assembly 154 to control the rotation direction and speed of the power tong 130 via one data connection to the motor assembly 154 to control the power tong 130 during operation and via another data connection to the automated evaluation module 220, wherein data related to motor operation is recorded and used for evaluation of the connection being made.

The automated makeup module 210 also sends out commands to the actuators 142, 144 to clamping and clamping forces in the backup tong 110 and the power tong 130 via a data connection to the actuators 142, 144 to control clamping and release of tubulars in the tong assembly 102 during operation and via another data connection to the automated evaluation module 220, wherein data related to clamping operation is recorded and used for evaluation of the connection being made.

Similarly, other operations commands from the automated makeup module 210 may also be connected to both the actuators and the automated evaluation module 220 for use in evaluation. In some configurations, operation parameters generated in the automated makeup module 210 but not sent out to any actuators, such as a determination of backup tong slippage, non-engagement between the tubulars, may be sent to the automated evaluation module 220 via a connection.

Measurements of the load cell 156 may be sent to the automated makeup module 210 and the automated evaluation module 220 through data connections. During operation, for example, the measurements of the load cell 156 may be sent to the automated makeup module 210 and the automated evaluation module 220 in synchronization or at different frequency and/or for different time periods according to the process design. Measurements of the load cell 156 may be used to determine torque applied to the threaded connection and used for controlling the makeup process and as basis for evaluating the threaded connection.

Measurements of the turns counter 158 may be sent to the automated makeup module 210 and the automated evaluation module 220 through data connections. During operation, for example, the measurements of the turns counter 158 may be sent to the automated makeup module 210 and the automated evaluation module 220 in synchronization or at different frequency and/or for different time periods according to the process design. Measurements of the turns counter 158 may be used to determine turns made by the motor to the threaded connection and used for controlling the makeup process and as basis for evaluating the threaded connection.

Measurements of the turns sensor 148 may be sent to the automated makeup module 210 and the automated evaluation module 220 through data connections. During operation, for example, the measurements of the turns sensor 148 may be sent to the automated makeup module 210 and the automated evaluation module 220 in synchronization or at different frequency and/or for different time periods according to the process design. Measurements of the turns sensor 148 may be used to determine turns made to the tubular clamped by the power tong 130 and used for controlling the makeup process and as basis for evaluating the threaded connection.

Measurements of the turns sensor 146 may be sent to the automated makeup module 210 and the automated evaluation module 220 through data connections. During operation, for example, the measurements of the turns sensor 146 may be sent to the automated makeup module 210 and the automated evaluation module 220 in synchronization or at different frequency and/or for different time periods according to the process design. Measurements of the turns sensor 146 may be used to determine backup tong slippage or coupling rotation and used for controlling the makeup process and as basis for evaluating the threaded connection.

Looking at the control system 200 in FIG. 2 in more detail, the automated makeup module 210 is configured to enable automated makeup (or breakout) process. The automated makeup module 210 may operate on a programmable logic controller (PLC) that is connected to actuators and sensors of the tong assembly 102. The automated makeup module 210 may include a control program that generates commands to control rotational speed of the power tong 130 according to the measured torque applied between the tubulars 10a-b in the tong assembly 102 or other operating conditions.

The makeup module 210 includes an operating sequence program 212 and a PID controller program 214. When operated, the operating sequence program 212 generates commands for the tong assembly 102 to perform an automated makeup process or automated breakout process. For example, the operating sequence program 212 sends commands to the tong assembly 102 to perform a plurality of steps for making up or breaking out a threaded connection. The PID controller program 214 is configured to control the tong assembly 102 at a certain stage of a makeup process to perform an automatic speed reduction operation to stop rotation when a threaded connection is made. The PID controller program 214 may be activated by the operating sequence program 212 when a trigger condition occurs. The trigger condition may include a measured torque between the tubulars reaches a predetermined value, rotation of the tubular has been performed for a predetermined time duration, or a predetermined turns is rotated between the first and second tubulars 10a-b.

During operation, the automated makeup module 210 monitors the various sensors 140 of the tong assembly 102, generates commands based on the sensor measurements, and sends out command signals to various components in the tong assembly 102 to complete the operation.

The automated evaluation module 220 is configured to automatically evaluate the threaded connection between the tubulars 10a-b based on process parameters and sensor measurements made during makeup. After the threaded connection is made using the automated makeup module 210, for example, the threaded connection can be evaluated by the automated evaluation module 220 so an artificial intelligence (AI) analysis module 232 of the analysis module 230 can determine whether the threaded connection is acceptable or should be rejected and remade due to one or more connection errors.

The evaluation module 220 can use an automated evaluation process, such as disclosed in U.S. Pat. Nos. 10,844,675 and 10,969,040, which is incorporated herein by reference. For example, the automated evaluation module 220 may include a measurement correlator 222, a graphical generator 224, and a connection evaluator 226. Each of these can operate together to evaluate the threaded connection. The measurement correlator 222 is configured to correlate measurements with recorded operating data to reduce false failure diagnosis by the connection evaluator 226. For example, the measurement correlator 222 may correct one or more of the measurements, such as time, torque, and/or turns, made during makeup before the measurements are used to evaluate the threaded connection by the connection evaluator 226. Accordingly, the measurement correlator 222 can correlate the torque measurements, turn measurements, and time measurements with operating information received from the automated makeup module 210.

For example, the measurement correlator 222 can correct for rotation of the coupling 20 when making up a threaded connection 15. Rotation of the coupling 20 relative to the backup tong 110 can affect the measurements of the turns counter (e.g., 148, 158) attached to the upper tubular 10b. Turning of the coupling 20 may be caused by backup tong 110 slippage or rotation between the coupling 20 and the lower tubular 10a. Turns of the upper tubular 10b measured by the turns counter 148 or turns counter 158 does not reflect the actual turns occurred in the threaded connection 15 being evaluated, which is the threaded connection between the tubulars 10a-b and the coupling 20.

The measurement correlator 222 can also correct turns measurement of the upper tubular 10b rotated by the power tong 130 with measurement of coupling turns. For example, when turns measurement from the turns counter 158 or 148 is used to evaluate the threaded connection 15, the turns measurement can be first corrected using turns measurement by the turns counter 146 or 148, which measure turns of the coupling 20 or the lower tubular 10a. Measurements of turns counter 146 are subtracted from the turns measurements of the turns counter 158 or 148. The coupling rotation correction removes potential false characterization of yielding through the torque-turn graph.

The measurement correlator 222 can also correct for dynamic changes of the power tong 130. Dynamic behavior of the tong assembly 102 can have a significant influence on torque-turn curves used in evaluating a threaded connection. The dynamic behavior is likely to create patterns in the torque-turn curve that appear unacceptable. For example, inertia of the tong assembly 102 during reducing speed on the power tong 130 can create a changing torque signature that resembles yielding. Therefore, the measurement correlator 222 can correlate recorded operating parameters, such as deaccelerating commands, with the torque measurements to identify and remove torque spikes caused by tong dynamics during decelerating. Similarly, other actions, such as acceleration and dumping, may be correlated to remove false failure patterns in the torque-turn curve or other graphs used for evaluation.

The measurement correlator 222 can also correct for flexible deformation of the tong assembly 102 that may occur during operations, such as when the tong assembly 102 carries the load of torque and/or weight, when the tongs 110, 130 clamp at the tubulars 10a-b, and when the clamping force is changed. For example, an increased clamping force will drive protrusions on the gripping pads deeper against the tubular being clamped, resulting in additional turns of the tong assembly 102 while the tubulars 10a-b clamped in the tong assembly 102 stay stationery. The flexible deformation sometime results in additional turns measured in the turns sensors, such as the turns counter 158, coupled to the tong assembly 102. The additional turns captured by the internal turns counters, such as the turns counter 158, do not reflect the actual turns of the tubulars. Instead, turns measurement, such as measurements from the turns counter 158, can be corrected according to commands of clamping, such as commands received from the automated makeup module 210 via data connections.

Correlating the operating information from the automated makeup module 210 with the automated evaluation module 220 makes it possible to correlate false failure patterns in the torque-turn graphs and other correlations in the graphical representation according to the mechanisms that caused the false failure patterns. The measurement correlator 222 may identify and remove false failure patterns that result from incorrect turns data like that described in the coupling rotation correction and the displacement correction. The measurement correlator 222 may also identify and remove false failure patterns that result from erroneous torque-turn data or noise like that described in the structure dynamic correction. In general, the measurement correlator 222 may account for false failure patterns caused by various tong operating parameters so that evaluation of the threaded connection is predominantly based on actual change in torque and turns of the threaded connection, thus increasing accuracy.

Using the corrected measurements, the graphical generator 224 is configured to generate torque-turn curves and/or other correlations. The torque-turn curves and other correlations may then be used by the connection evaluator 226 to detect and graph markers indicative of an unacceptable threaded connection. For example, the connection evaluator 226 includes various algorithms used to process measured data and identify evaluation and markers indicative of an unacceptable threaded connection. Likewise, the evaluations and markers from the connection evaluator 226 can be added to the graphical representations produced by the graphical generator 224.

In turn, as discussed in more detail below, the AI analysis model 232 of the analysis module 230 uses the graphical representations having torque-turn curves, corrections, evaluations, markers, and other information produced by the graphical generator 224 and the evaluator 226 to determine an acceptable/unacceptable threaded connection according to one or more possible connection errors.

The AI analysis module 230 can use forms of analysis, such as disclosed in incorporated U.S. Pat. Nos. 10,844,675 and 10,969,040. In particular, the AI analysis model 232 analyzes the graphical representations of the torque-turn curves, other correlations, evaluations, markers, and other information to determine one or more connection errors of the threaded connection. The connection errors can include a lack of connection; a discontinuity between torque, turns, and/or time for the threaded connection; a torque spike; a final torque value and a dump, a torque drop, an improper shouldering, etc. For example, the connection evaluator 226 evaluates the measured turns, measured torque, and/or measured time and generates the evaluated information, which the graphical generator 224 puts into one or more graphical representations. The AI analysis model 232 then analyzes the one or more graphical representations to determine whether the threaded connection has a connection error. If a connection error is identified, the AI analysis model 232 then rejects the threaded connection so the connection between tubulars 10a-b can be broken and additional handling can be performed. Otherwise, the AI analysis model 232 can accept the threaded connection so the tubular handling process can proceed.

### B. Process

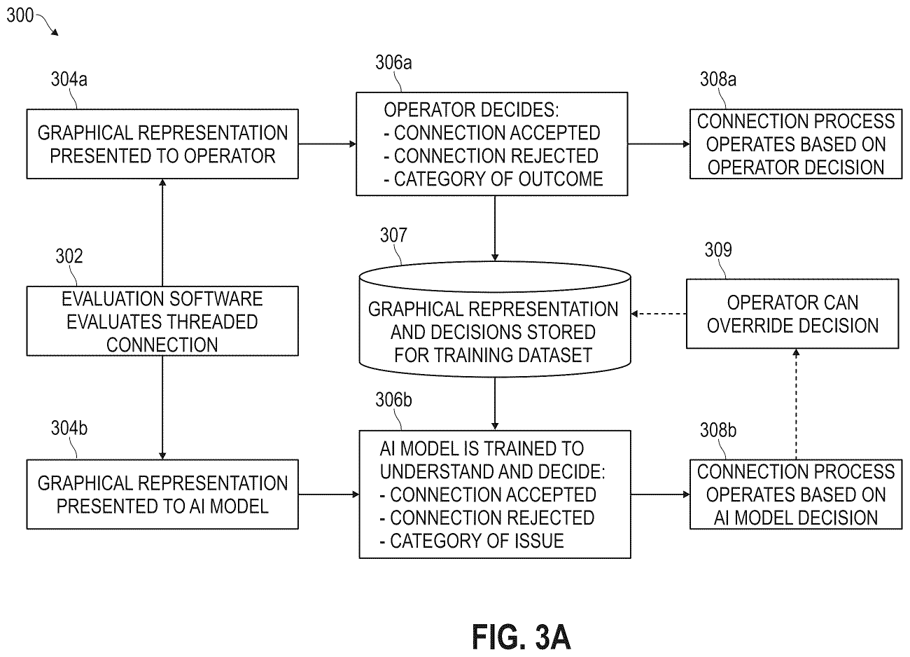

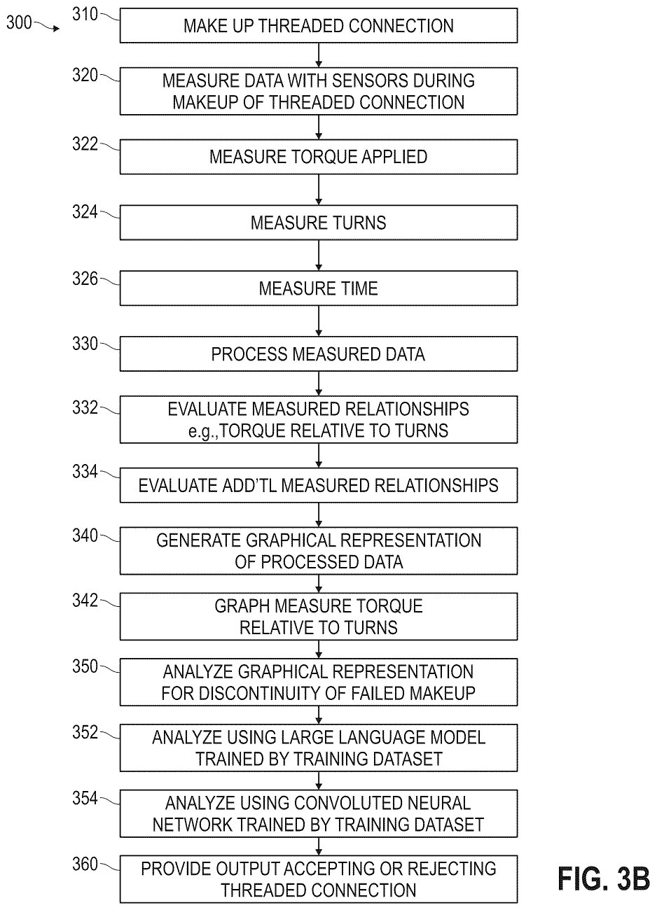

FIG. 3A illustrates a process 300 of integrating the disclosed systems and methods into making up threaded connections for tubulars. (Reference numerals to elements in other figures are provided in the discussion below.)

Initially during real-time operations of the process 300, the connection equipment 100 and the control system 200 are used to make up threaded connections between tubulars 10a-b in tubular handling operations. The control system 200 evaluates the threaded connections by collecting measured data and processing the measured data to produce calculated values, graphs, and the like, which are generated in graphical representations (Block 302). As noted, the control system 200 can have an evaluation module 220 to perform the evaluations and generate graphical representations. The evaluations can be similar to those disclosed in incorporated U.S. Pat. Nos. 10,844,675 and 10,969,040. These graphical representations, which can include images of graphs, tables, spreadsheets, and other graphics, are presented to the operator (Block 304a), who is operating the connection equipment 100 making up the threaded connection between the tubulars 10a-b.

The operator reviews the graphical representations, which can be output on a display or other output device 206. The operator decides to accept or reject the threaded connection and also categorizes the outcome associated with the threaded connection (Block 306a). The outcome can indicate whether there is any connection error in the threaded connection, including a lack of connection; a discontinuity between torque, turns, and/or time for the threaded connection; a torque spike; a final torque value and a dump, a torque drop, an improper shouldering, etc.

The connection process 300 can then proceed based on the operator's decision or assessment of the threaded connection (308a). If the threaded connection is accepted, for example, additional handling operations can commence on the rig floor so the tubing string 30 can be run into the well. If the threaded connection is rejected, the threaded connection may be broken out by the connection equipment 100 so it can be made up again. Each operator's assessment and the graphical representations on which it was based are stored to produce a training dataset for the AI analysis model 232 of the connection process 300 (Block 307).

Eventually, a sufficient corpus of training data is produced offline. The AI analysis model 232 is then trained using the large dataset of historical graphical representations (graphs, images, etc.) and their corresponding assessments (the outcomes accepting or rejecting the threaded connection as well as the category of the connection error). The trained AI analysis model 232 is then integrated into the existing software used for evaluating and controlling the equipment and processes for making the tubular connections.

Now, during real-time operations, the evaluation module 220 evaluates the threaded connections as before by collecting the measured data and processing the measured data to produce calculated values, graphs, and the like, which are used to generate graphical representations (Block 303). The graphical representations are then presented to the AI analysis model (Block 304b). The graphical representations may also be presented to the operator as before (Block 304a). The AI analysis model 232 then analyzes the graphical representations and provides instant feedback on the quality of each threaded connection, including detailed descriptions of any detected connection errors (Block 306b). The analysis can be similar to those disclosed in incorporated U.S. Pat. Nos. 10,844,675 and 10,969,040. The control system (200) can output the results in any number of output formats, including a visual alarm to the operator, an audible alarm to the operator, a graphical user interface to the operator, and an automated control to the connection equipment to break the threaded connection.

The connection process 300 can then operate based on the AI analysis model's decision or assessment (Block 308b). Of course, the operator can override the AI analysis model's assessment, either accepting or rejecting the threaded connection (Block 309). The results of the operator's override can be stored to build the repository of the training dataset (307) used to train and further refine the AI analysis model 232 (306b). For example, the control system 200 can receive choices of the model's assessments. The choices are user-indicated by the operator and can either confirm or decline the model's acceptance/rejection of the threaded connection. The AI analysis model implemented on the control system 200 can then be trained with the graphical representations based on the user-indicated choices.

FIG. 3B illustrates further details of the process 300 of making up and evaluating threaded connections of tubulars 10a-b according to the present disclosure. (Reference numbers to elements in other figures are provided in the discussion below.)

The process 300 begins with the connection equipment 100 making up a threaded connection of the tubulars 10a-b (Block 310). For example, the connection equipment 100 can include a tong assembly 102 that applies torque in rotating one of the tubulars 10b in turns relative to the other of the tubulars 10a. The makeup module 210 of the control system 200 can automate and control the operation of the connection equipment 100 during the makeup operation.

During the makeup of the threaded connection, the process 300 involves data collection in which torque, turns, time, and other relevant data is collected when making up the threaded connection of the tubulars 10a-b (Block 320). For example, sensors 140 (associated with the connection equipment 100) measure data during the makeup of the threaded connection (Block 320). The measured data can include the torque applied in rotating the upper tubular 10b (322), the turns (or portion thereof) used in rotating the upper tubular 10b (324), and the time involved in making up the threaded connection 15 (326). These and other measurements can be made as noted herein.

The control system 200 then processes the measured data (Block 330) and generates a graphical representation of the processed data (Block 340). After makeup of the threaded connection, for example, the makeup evaluation module 220 of the control system 200 can evaluate the threaded connection based on the measured data and can generate torque-turn curves and other graphical representations from the evaluations.

At this point in the process 300, the trained AI analysis model 232 is implemented in the computing environment 50 and performs an analysis of the graphical representation for at least one connection error indicative of a failed makeup of the threaded connection (Block 350). As noted, computing implemented in the computing environment 50 can include using the control system 200 and/or a remote system 60, such as a cloud-based system. Depending on the capabilities of the control system 200, for example, computing for the trained AI analysis model 232 may use the cloud-based system or other remote system 60. As also noted, the at least one connection error can include an equipment malfunction (e.g., a torque leap, a turns leap, etc.), a lack of connection, a torque spike, a heavy torque drop, improper shouldering, and the like.

Overall, the processing (330) by the makeup evaluation module 220 can compare, correlate, graph, and perform other functions with the measured data. Moreover, the processing (330) by the makeup evaluation module 220 can use the measured data to calculate various operational results that characterize the threaded connection, the operation of the connection equipment, and other parameters. During the graphical generation, the makeup evaluation module 220 can compile and organize the processed data to produce images, graphs, visuals, and other graphical representations, which can be saved in any suitable electronic formats in storage. The trained AI analysis model 232 accesses these graphical representations in storage to perform its analysis. The graphical representations can also be displayed on a monitor or other output device 206 for the operator.

In the processing (330), various evaluations can be performed on the measured data. For example, the processing (330) can involve evaluating the measured relationships (e.g., measured torque applied to the threaded connection relative to the measured turns of the tubular being rotated) (Block 332). In this case, the graphical generating (340) can involve graphing a torque-turn curve of the measured torque relative to the measured turns (Block 342).

In the subsequent analysis (350) of a graphical representation having such a curve, the trained AI analysis model 232 can analyze the torque-turns curve in a number of ways. For example, the analysis (350) performed by the trained AI analysis model 232 can compare the measured turns in the curve relative to a minimum turns threshold and can compare the measured torque in the curve relative to a minimum torque threshold. Based on the analysis, the trained AI analysis model 232 can then determine a lack of connection has occurred. For example, a lack of connection can occur when the measured turns value fails to exceed a minimum turns threshold, such as 0.05 turns, or when the measured torque value fails to exceed a minimum torque threshold, such as twenty percent of the minimum final torque value for an acceptable connection.

In another example, the analysis (350) performed by the trained AI analysis model 232 can compare the measured torque in the curve relative to a maximum torque threshold and can determine a torque spike as being indicative of the at least one connection error. For example, a significant increase in the measured torque is referred to as a torque spike. Having such a torque spike exceed a torque threshold indicates that there is an unacceptable connection between the tubulars 10a-b. A time threshold (e.g., twenty milliseconds) may also be used to evaluate whether a torque spike has occurred. As a result, an unacceptable connection between the tubulars 10a-b may be indicated when a single torque spike meets both the torque threshold and time threshold.

The trained AI analysis model 232 can review the measured torque in a torque-turns curve relative to start and end values and can determine whether a torque drop indicative of a connection error has occurred. For example, the threaded connection may fail if a heavy torque drop is detected after the shoulder point in the threaded connection. The torque drop is measured in terms of the width (span) in time and/or the width (number or portion) in the turns to make the threaded connection, the torque and turn values before and after the torque drop, the minimum torque value at the torque drop, the turn gradient or change in the turns with respect to time, and the second derivative of turns with respect to time.

In yet other examples, the analysis (350) performed by the trained AI analysis model 232 can evaluate the measured torque in the curve changing relative to the measured turns being constant. From this evaluation, the trained AI analysis model 232 can determine whether a significant increase in measured torque at constant measured turns has occurred, which is indicative of a torque leap as the connection error. As a corollary, the analysis (350) performed by the trained AI analysis model 232 can evaluate the measured turns in the curve changing relative to the measured torque being constant. From this evaluation, the trained AI analysis model 232 can determine whether a significant increase in measured turns at constant measured torque has occurred, which is indicative of a turns leap as the connection error.

In addition to detecting any leaps, the analysis (350) performed by the trained AI analysis model 232 can evaluate the torque-turns curve for an indicated pattern. From this evaluation, the trained AI analysis model 232 can determine, based on the indicated pattern in the torque-turns curve, whether there is an issue associated with at least one of the connection equipment and the threaded connection as the at least one connection error. Various indicated patterns can be analyzed, including an irregular pattern, a repeating pattern, and an oscillating pattern. From the evaluation of these various indicated patterns, the trained AI analysis model 232 can determine whether there is an issue with misalignment between the tubulars, an issue with threading in the threaded connection, an issue with mechanics of the connection equipment, an issue with a gear in the connection equipment, an issue with hydraulics of the connection equipment, and an issue with disruptive movement of the connection equipment. Overall, the indicated patterns can be related to a machine-based issue, such as a broken gear, a hydraulic fluid-based problem, the power tong 130 being hit by objects on the rig floor, etc. Also, the indicated patterns can be related to connection-dependent issues, rig environment-dependent issues, etc.

The torque leap and turns leap may be caused by equipment malfunctions. For example, the torque leap may be the result of a defective torque cell of the equipment's sensors 140. Meanwhile, the turns leap may be the result of a defective turns counter of the equipment's sensors 140. Other examples of connection errors caused by equipment malfunctions include repeating time values, time or turns counting backwards, incorrect sampling frequency, and other significant changes in measured turns or torque.

In a further example, shouldering during make up of the threaded connection is expected based on the torque and turns made and may be defined by the specifications for the connection. Peaks in torque and turns can occur, but they may or may not correspond to the shouldering. The analysis (350) performed the trained AI analysis model 232 can review the torque-turns curve for an angle between (i) a first line between a start point and a first point at which a circle overlaid on the start point intersect the curve, and (ii) a second line between the start point and a second point at which the circle overlaid on the start point intersect the curve. Based on the angle, the trained AI analysis model 232 can determine that improper shouldering has occurred as the connection error.

In another example, the analysis (350) of the trained AI analysis model 232 can review the torque-turns curve for an angle between a first line and a second line in which (i) a first line extends from a measured final torque value on the curve to a point along the curve, and (ii) a second line extends from a measured starting torque value on the curve to that point. Based on the angle, a shoulder position can be determined, and improper shoulder can be determined as connection error.

In addition to any such geometric analytics, the analysis (350) performed by the trained AI analysis model 232 can evaluate the torque-turns curve for a particular deviation indicative of physical contact within the threaded connection or lack thereof. From this evaluation, the trained AI analysis model 232 can determine, based on the deviation, whether there is an issue associated with a shouldering point in the connection being indicative of the at least one connection error.

For example, in analyzing the torque-turns curve for the deviation, the trained AI analysis model 232 can receive a manual indication of the shouldering point, such as input by a user. Evaluating that manual indication, the trained AI analysis model 232 can determine if there is an issue or if the shouldering point is proper. In another example, the trained AI analysis model 232 can evaluate the torque-turns curve for a spike indicative of physical contact within the threaded connection. Based on the spike, the trained AI analysis model 232 can return an indication of a proper shouldering point. In yet another example, the trained AI analysis model 232 can evaluate the torque-turns curve for at least one of a hump, a drop, an irregular deviation, and an absence of a spike indicative of physical contact within the threaded connection, and the trained AI analysis model 232 can return an indication of an improper shouldering point.

Overall, the trained AI analysis model 232 can evaluate the graphical representation and can return the shoulder position. In general, the shoulder position corresponds to an evident spike (kink) in the graphed curve that occurs when physical contact is made within the threaded connection. The trained AI analysis model 232 can return an indication of the shoulder point or can indicate an error when the shoulder point cannot be found.

The processing (330) can involve evaluating additional measured relationships, such as the measured turns over the measured time, the measured torque over the measured time, and/or the measured torque values over the measure turns (Block 334). In this instance, the measured relationships (e.g., the measured turns over the measured time, the measured torque values over the measured time; and/or the measured torque values over the measure turns) can be incorporated in the graphical representations (Block 340). The analysis (350) of the trained AI analysis model 232 can determine a decrease in these measured relationships being indicative of a connection error.

In the analysis (350), different artificial intelligence models and techniques can be used for the AI analysis models 232 to analyze the graphical representations. In one artificial intelligence technique, the graphical representation is described using a large language model (LLM), and the generated text is then analyzed by the LLM to determine whether the threaded connection is acceptable or has a connection error. For example, the analysis of the graphical representation can be implemented by a large language model (LLM) trained by a dataset of training graphical representations (Block 352). Graphical data in the graphical representation is input in the trained LLM, which converts the graphical data into descriptive text. In turn, the descriptive text is then analyzed with the artificial intelligence model, such as the same or different LLM, for a connection error.

In another artificial intelligence technique, a convolutional neural network (CNN) or an LLM is trained using historical training data to directly evaluate graphs and other information of the graphical representations to determine whether the threaded connection is acceptable or has a connection error. For example, the analysis of the graphical representation can be implemented by a convolutional neural network (CNN) trained by a dataset of training graphical representations (Block 354). Graphical data in the graphical representation can be analyzed directly with the CNN for the connection error.

Finally, after analyzing the graphical representations for a connection error in the process 300 of FIG. 3B, the control system 200 then provides an output accepting or rejecting the threaded connection based on the analysis (Block 360). Various forms of output can be provided. For example, information may be displayed to the operator on a display or other output device 206. In another example in response to the determined connection error, the trained AI analysis model 232 may instruct the controller 202 to operate the tong assembly 102 to breakout the connection so a new makeup operation can be attempted.

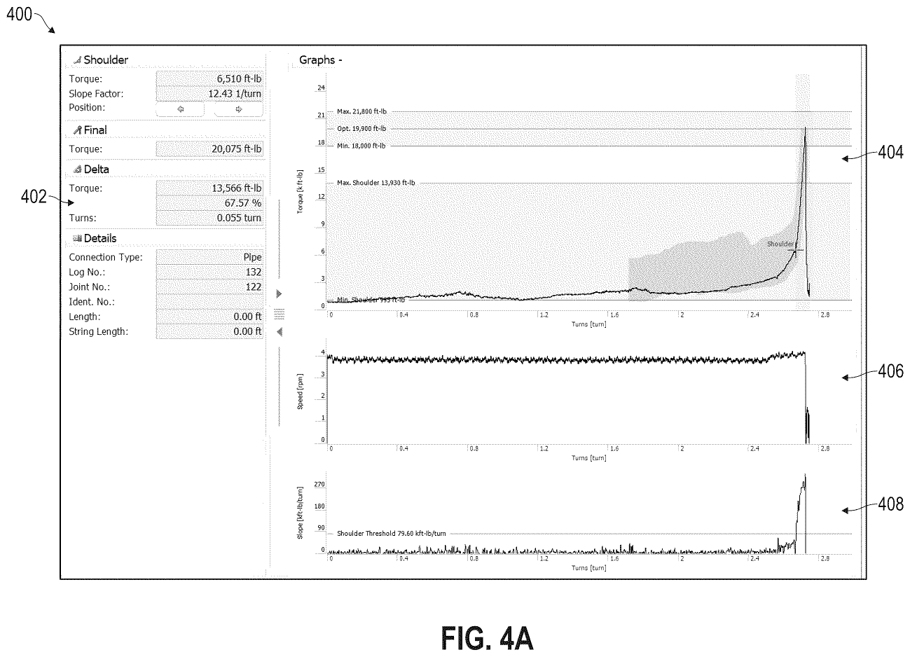

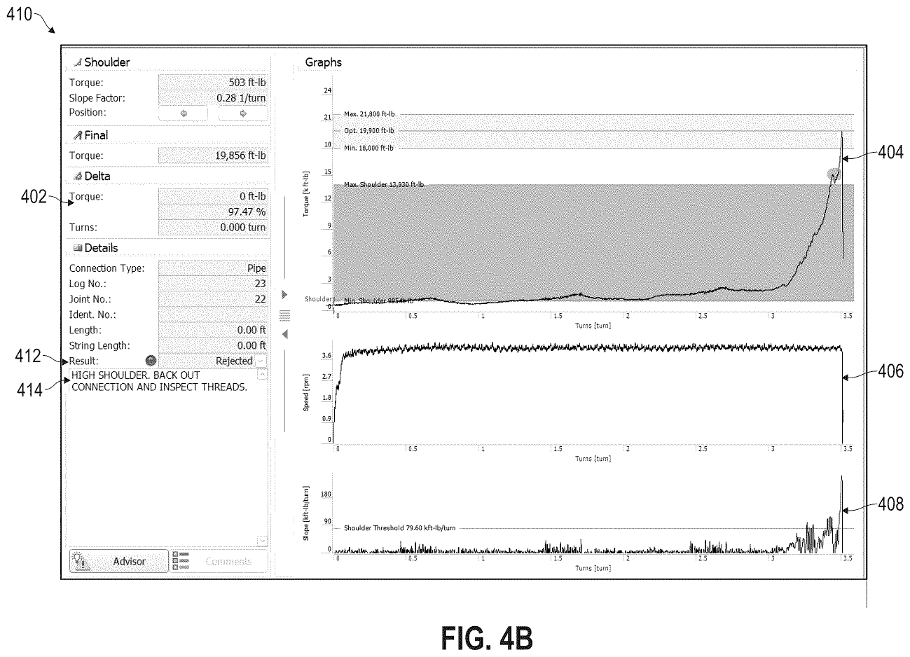

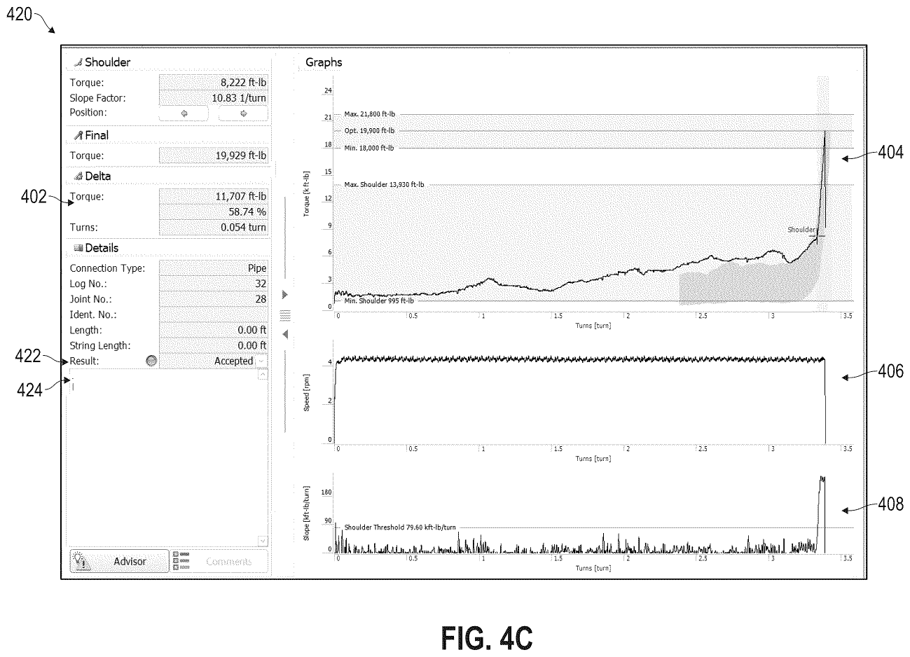

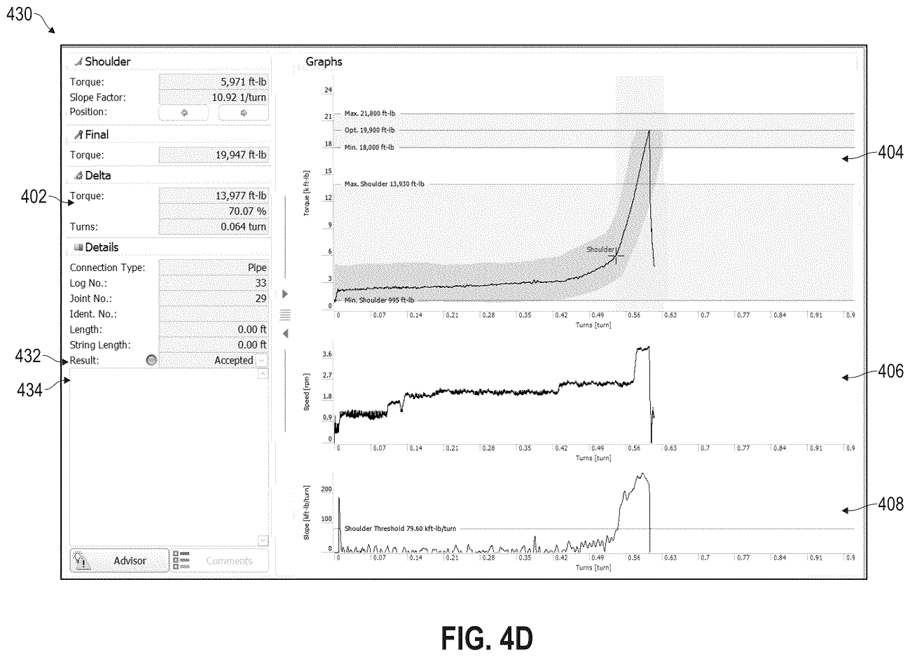

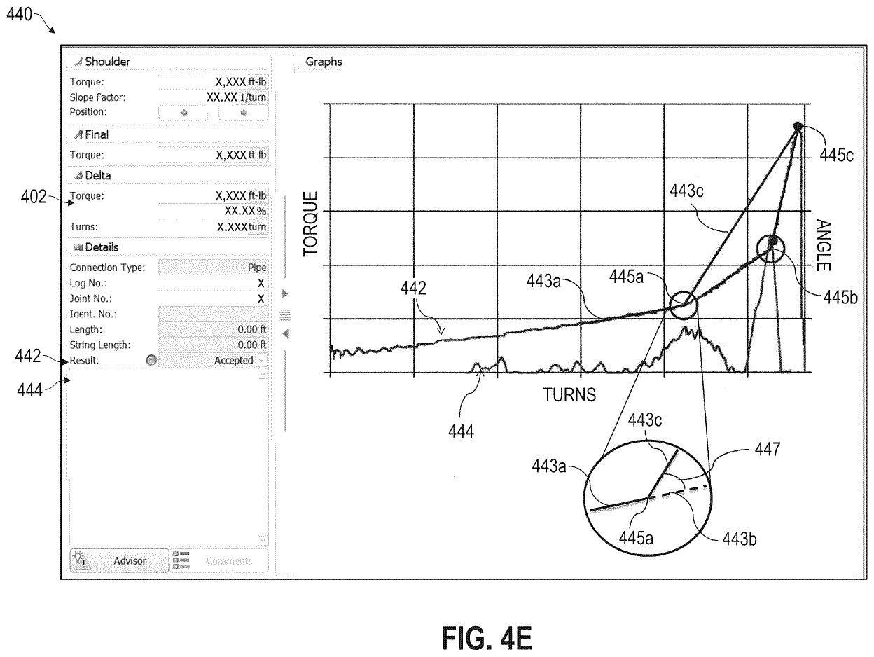

FIGS. 4A-4E illustrate examples of graphical representations of the present disclosure for use in the disclosed systems and methods. In FIG. 4A, the graphical representation 400 represents an image file of a graphical user interface that may be generated by the evaluation module (220) of the control system (200) after receiving and processing the sensor data measured by the sensors (140) during makeup of the threaded connection. The trained AI analysis model (232) can extract calculated values, measurements, and other tabulated information from tables 402 in the graphical representation 400. Examples shown here include a shouldering table (torque, slope factor); a final torque; a delta table (torque, turns, percentage); and connection details (type, log number, etc.).

The trained AI analysis model (232) can also analyze graphs and curves in the graphical representation 400. Examples shown here include a torque-turns curve 404 plotting torque versus turns; a speed-turns curve 406 plotting speed versus turns; and a slope-turns curve 408 plotting slope (torque-per-turn kft-lb/turn) versus turns. The graphs for these curves 404, 406, 408 can include appropriate thresholds and limits, such as a maximum torque threshold, a minimum torque threshold, a maximum shouldering torque, a minimum shouldering torque, a shoulder threshold.

Othe graphs and curves can be provided in the graphical representation 400. For example, a graph can include overlaid curves, such as the torque-turn curve 404 overlaid on an angle-turns curve. Such an angle-turns curve may depict measured angle values and corresponding measured turns values according to methods for shoulder detection.

The graphs and curves can also include evaluated information, such as overlay lines on a graphed curve, histograms, bar charts, enhancements, etc. For instance, overlay lines can be depicted at a starting measured torque values to a point along the torque-turns curve 404, from a final measured torque value to the point, a calculated angle between overlay lines, and other details useful in detection of the shouldering in the threaded connection. In another example, a first derivative calculated from the torque-turns curve 404 can be graphed and can have an inflection point corresponding to the location of the shoulder. In yet another example, a histogram may be created from points of the first derivative of the torque-turns curve, and clusters of the points on the histogram can indicate the location of the shoulder.

In FIG. 4B, the example graphical representation 410 can be used in training the AI analysis model (240) of the disclosed control system (200). Again, the graphical representation 410 represents an image file of a graphical user interface that may be generated by the evaluation module (220) of the control system (200) after receiving and processing the sensor data measured by the sensors (140) during makeup of the threaded connection. The graphical representation 410 includes tables 402 and curves 404, 406, 408 as before.

In addition to these depictions, the graphical representation 410 includes a determined result or assessment 412 (e.g., rejected or accepted) for the threaded connection and includes an explanation or reasons 414 for the determination. In this example, the result 412 indicates that the threaded connection was rejected, and the reason 414 indicates that a high shoulder was encountered so the threaded connection needed to be backed out to inspect the thread. Because this graphical representation 410 is to be used in training the AI analysis model (240), the result 412 and the reason 414 may have been input by an operator reviewing the threaded connection.

FIG. 4C illustrates another example of a graphical representation 420 that can be used in training the AI analysis model (240) of the disclosed control system (200). In this example, a result or assessment 422 indicates that the threaded connection was accepted. A reason 424 may or may not be indicated. FIG. 4D illustrates yet another example of a graphical representation 430 that can be used in training the AI analysis model (240) of the disclosed control system (200). In this example, a result or assessment 432 indicates that the threaded connection was accepted. A reason 434 may or may not be indicated.

FIG. 4D illustrates another example of a graphical representation 420 that can be used in training the AI analysis model (240) of the disclosed control system (200). This graphical representation 420 includes a graph having a torque-turns curve 442 showing torque relative to turns and having an angle-turns curve 444. Details related to angle are also depicted, including evaluated lines 443a, 443b, 443c, circles, and points 445a, 445b, 445c to determine an angle 447 for shoulder position. As detailed previously and disclosed in incorporated U.S. Pat. No. 10,969,040, the angle 447 can be defined between (i) a first line between a start point and a first point at which a circle overlaid on the start point intersect the curve, and (ii) a second line between the start point and a second point at which the circle overlaid on the start point intersect the curve. The angle 447 can be between a first line and a second line in which (i) a first line extends from a measured final torque value on the curve to a point along the curve, and (ii) a second line extends from a measured starting torque value on the curve to that point.

The systems and methods of the present disclosure address the inefficiencies and potential inaccuracies associated with both manual and basic evaluations of threaded tubular connections in oil drilling operations. For example, the disclosed systems and methods provide faster decision-making compared to manual evaluations and reduce the need for human intervention, minimizing errors and increasing consistency in the evaluation process. This enhances operational efficiency and accuracy in accepting or rejecting connections in tubular running systems. Furthermore, the disclosed systems and methods can provide detailed descriptions and potential fault identifications, enhancing maintenance and corrective actions.

### C. Natural Language Processing

As noted above, the disclosed systems and methods use AI techniques, such as a large language model (LLM) for image-based evaluations. In one technique, an LLM converts graphical data into descriptive text, which is then analyzed to determine the acceptability of the connection. In another technique, an LLM is trained directly with graphical representation to evaluate and classify the quality of the threaded tubular connections.

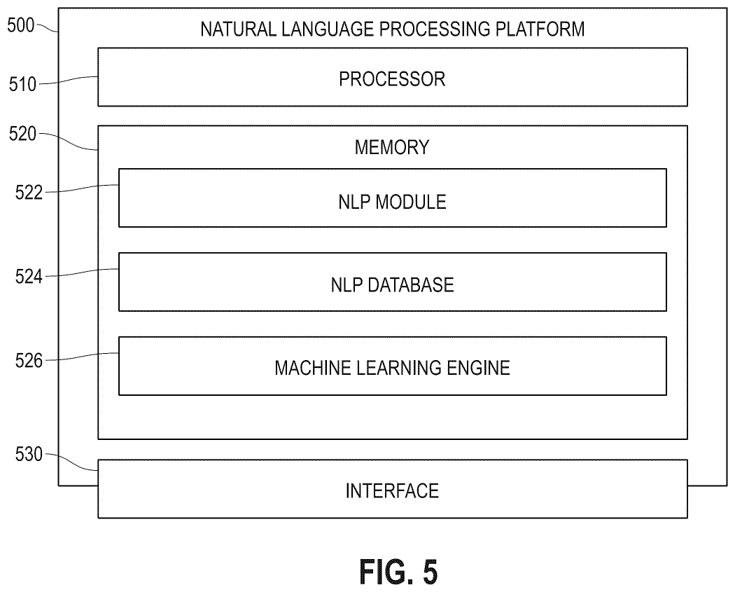

FIG. 5 schematically illustrates a natural language processing (NLP) platform 500 for automated evaluation and analysis of graphical representations in a computing environment (50). (Reference numerals to elements in other figures are provided in the discussion below.)

As noted, the computing environment (50) includes the control system (200), the remote system (60), and processes (300) discussed above. The NLP platform 500 can be implemented on one or more computing devices configured to perform one or more of the functions described herein. For example, the NLP platform 500 can be implemented on the control system (200), including the programmable logic controller 202 and/or one or more computers (e.g., laptop computers, desktop computers, tablets, etc.) at the rig.

As disclosed herein, the NLP platform 500 is configured to perform NLP processing techniques by (i) converting a graphical representation of the makeup operation of the threaded tubular connection into descriptive text and (ii) then analyzing the descriptive text to determine if the threaded connection includes at least one connection error indicative of a failed connection. Additionally, the NLP platform 500 can maintain a model for dynamic performance evaluation and training that the NLP platform 500 may use to generate and analyze the descriptive text of the graphical representation.

The NLP platform 500 includes one or more processors 510, memory 520, and interface 530. A data bus (not shown) may interconnect the processor 510, the memory 520, and the interface 530. The interface 530 can include a graphical user interface for providing information to the operator of the connection equipment (100). The interface 530 can also include an equipment interface, such as a serial bus, a wireless connection, a wired connection, etc., to interface with the connection equipment (100) and any local programmable logic controller (202) of the connection equipment (100). Finally, the interface 530 can be a network interface configured to support communication between the NLP platform 500 and one or more networks (not shown).

The memory 520 includes one or more program modules having instructions that when executed by the processor 510 cause the NLP platform 500 to perform one or more functions. Additionally, the memory 520 includes one or more databases that store and maintain information that the program modules use. In some instances, the one or more program modules and/or databases may be stored in different memory units of the NLP platform 500 and/or stored by different computing devices that make up the NLP platform 500. As shown in this example, the memory 520 includes an NLP module 522, an NLP database 524, and a machine learning engine 526.

The NLP platform 500 may have instructions that direct the NLP platform 500 to execute advanced natural language processing techniques. The memory 520 may include several components or modules as illustrated. The NLP database 524 may store information used by the NLP module 522 in performing the functions disclosed herein. The machine learning engine 526 may have instructions that direct the NLP platform 500 to identify and summarize text in the graphical representations and to identify and describe features in the graphical representations indicative of at least one connection error associated with the threaded connection. The machine learning engine 526 can also set, define, and iteratively refine optimization rules and other parameters used by the NLP platform 500.

### D. Convolutional Neural Network

As noted above, the disclosed systems and methods use AI techniques, such as a convolutional neural network (CNN) for image-based evaluations. The CNN is trained directly with graphical representations to evaluate and classify the quality of the threaded tubular connections.

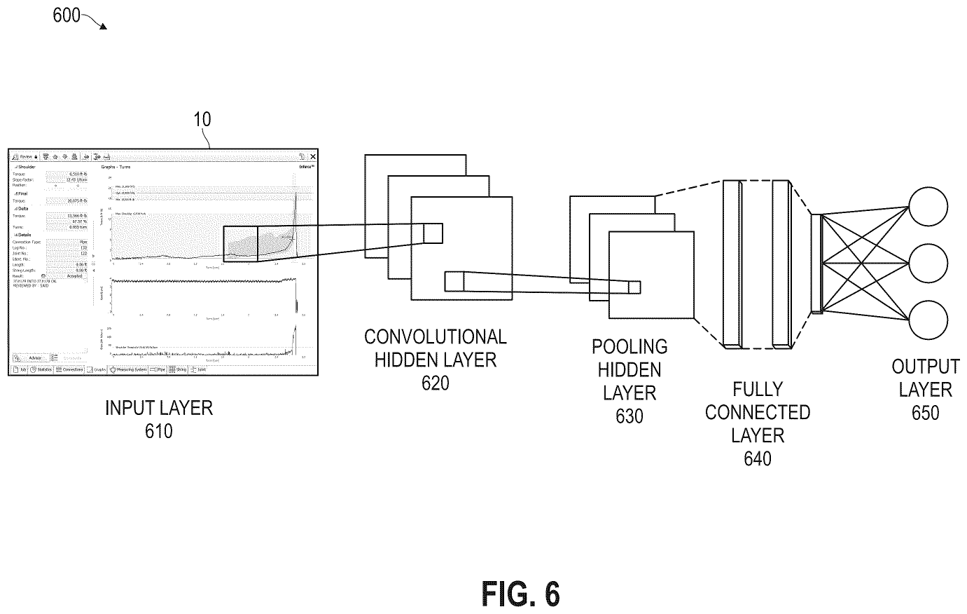

FIG. 6 schematically illustrates a convolutional neural network (CNN) 600 used for automated evaluation and analysis of graphical representations in a computing environment (50). (Reference numerals to elements in other figures are provided in the discussion below.)

Again, the computing environment (50) may include the control system (200) and/or the remote system (60) and includes processes (300) discussed above. The CNN 600 is a type of deep neural network (DNN) having three additional features: local receptive fields, shared weights, and pooling. An input layer 610 and an output layer 650 of the CNN 600 function similar to the input and output layers of a DNN. However, the CNN 600 is distinguished from a DNN in that hidden layers of the DNN are replaced with one or more convolutional hidden layers 620, pooling hidden layers 630, and fully connected hidden layers 640.

Using localized receptive fields, nodes in the convolutional hidden layers 620 receive inputs from localized regions in the previous layer. Meanwhile, using shared weights, each node in a convolutional hidden layer 620 assigns the same set of weights to the relative positions of a localized region.

The input layer 610 of the CNN 600 includes data representing an image (e.g., a graphical representation, graphical user interface, graphs, curves, tables, etc. produced by the evaluation module 220). For example, the data can include an array of numbers representing the pixels of the image, with each number in the array including a value from 0 to 255 describing the pixel intensity at that position in the array. The image can be passed through a convolutional hidden layer 620, an optional non-linear activation layer (not shown), a pooling hidden layer 630, and fully connected hidden layers 640 to get an output at the output layer 650. While only one of each hidden layer is shown in the present example, it is appreciated that multiple convolutional hidden layers 620, non-linear layers, pooling hidden layers 630, and/or fully connected hidden layers 640 can be included in the CNN 600.

The first layer of the CNN 600 is the convolutional hidden layer 620, which analyzes the image data of the input layer 610. Each node of the convolutional hidden layer 620 is connected to a region of nodes (pixels) of the input image called a receptive field. The convolutional hidden layer 620 can be considered as one or more filters (each filter corresponding to a different activation or feature map), and each convolutional iteration of a filter can be considered a node or neuron of the convolutional hidden layer 620. For example, the region of the input image that a filter covers at each convolutional iteration would be the receptive field for the filter. Each connection between a node and a receptive field for that node learns a weight and, in some cases, an overall bias such that each node learns to analyze its particular local receptive field in the input image. Each node of the convolutional hidden layer 620 will have the same weights and bias (called a shared weight and a shared bias). For example, the filter has an array of weights (numbers) and the same depth as the input.

The convolutional nature of the convolutional hidden layer 620 is due to each node of the convolutional layer being applied to its corresponding receptive field. At each convolutional iteration, the filter's values are multiplied by a corresponding number of the original pixel values of the image data. The multiplications from each convolutional iteration can be summed together to obtain a total sum for that iteration or node. The process is continued at a next location in the input image according to the receptive field of the next node in the convolutional hidden layer 620. For example, a filter can be moved by a step amount to the next receptive field. Processing the filter at each unique location of the input volume produces a number representing the filter results for that location, resulting in a total sum value being determined for each node of the convolutional hidden layer 620.

The mapping from the input layer 610 to the convolutional hidden layer 620 is referred to as an activation map (or feature map). The activation map includes a value for each node representing the filter results at each location of the input volume. The activation map can include an array containing the various total sum values resulting from each iteration of the filter on the input volume. The convolutional hidden layer 620 can include several activation maps to identify multiple features in an image.

Applied after the convolutional hidden layer 620, the pooling hidden layer 630 simplifies the information in the output from the convolutional hidden layer 620. The pooling hidden layer 630 takes each activation map output from the convolutional hidden layer 620 and generates a condensed activation map using a pooling function. Max-pooling is one example of a pooling function that can be performed by the pooling hidden layer 630. The pooling hidden layer 630 may also use other known forms of pooling functions. The pooling function is applied to each activation map in the convolutional hidden layer 620.

In the final layer of connections in the CNN 600, the fully connected hidden layer 640 connects every node from the pooling hidden layer 630 to every one of the output nodes in the output layer 650. The fully connected hidden layer 640 obtains the output of the previous pooling hidden layer 630 (which should represent the activation maps of high-level features) and determines the features that most correlate to a particular class. For example, the fully connected hidden layer 640 can determine the high-level features that most strongly correlate to a particular class and can include weights (nodes) for the high-level features. A product can be computed between the weights of the fully connected hidden layer 640 and the pooling hidden layer 630 to obtain probabilities for the different classes. For example, if the CNN 600 is being used to predict that an object is a torque-turns curve, high values will be present in the activation maps that represent high-level features of a torque-turns curve.

### E. Training Neural Network

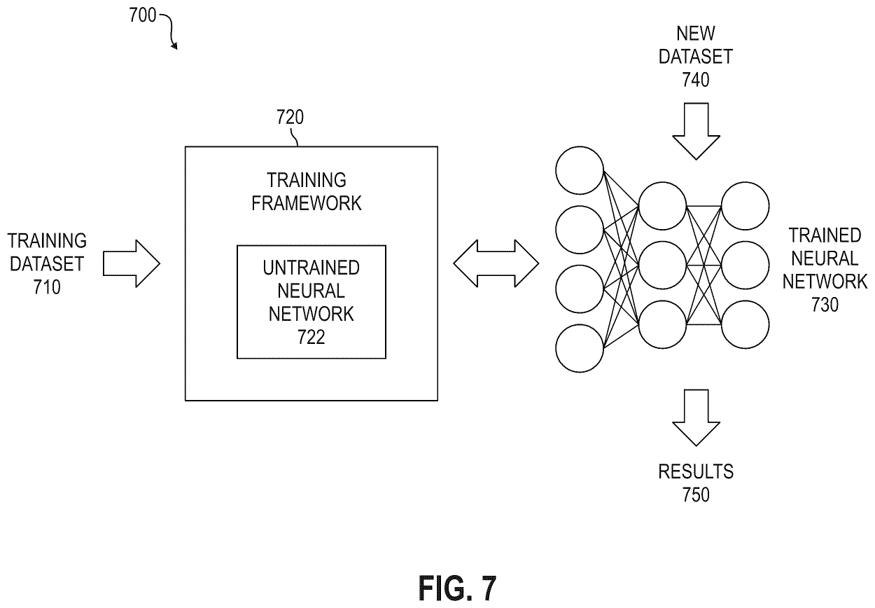

FIG. 7 illustrates an example of training and deployment of a deep neural network (DNN), such as the CNN 600 of FIG. 6. A network is structured for a task (e.g., to evaluate and analyze graphical representations for connection errors in threaded tubular connections). Once structured, the neural network is trained using a training dataset 710. As noted above with respect to FIG. 3A, the training dataset 710 can include historical graphical representations produced during makeup of threaded connections, in which an operator has accepted or rejected a connection in a decision or assessment and has categorized the outcome or reason for that assessment.

To begin training the DNN 700, initial weights may be chosen randomly or by pre-training using a deep belief network. A training cycle can then be performed in either a supervised or unsupervised manner.

Supervised learning uses the training dataset 710 to teach an untrained neural network 722 to yield a desired output. The training dataset 710 includes inputs and desired outputs so the untrained neural network 722 can learn over time. Alternatively, the training dataset 710 can include inputs having known outputs so the outputs of the untrained neural network 722 can be manually graded. Either way, the untrained neural network 722 processes the inputs and compares the resulting outputs against a set of expected or desired outputs. Errors are then propagated back through the training cycle. The training framework 720 can change the weights that control the untrained neural network 722. The training framework 720 can also provide tools to monitor how well the untrained neural network 722 is converging towards a model suitable for generating correct answers based on known input data. The training process repeatedly occurs as the network weights are adjusted to refine the output generated by the neural network 722. The training process can continue until the neural network 722 reaches a statistically desired accuracy associated with a trained neural network 730. In turn, the trained neural network 730 can then be deployed to implement any number of machine learning operations to output a result 750 when given a new dataset of graphical representation during real-time operations in a tubular running operation.

Supervised learning is typically separated into two types of problems—classification and regression. Classification uses an algorithm to assign test data accurately into specific categories. Regression is used to understand the relationship between dependent and independent variables. Numerous different algorithms and computation techniques can be used in supervised machine learning, including but not limited to, neural networks, naïve bayes, linear regression, logistic regression, support vector machines (SVM), k-nearest neighbor, and random forest.

Unsupervised learning is a learning method in which the untrained neural network 722 uses algorithms to analyze and cluster unlabeled data. These algorithms discover hidden patterns or data groupings. Therefore, the training dataset 710 includes input data without any associated output data. The untrained neural network 722 can learn groupings within the unlabeled input and determine how individual inputs relate to the overall dataset. Unsupervised training can be used for three main tasks—clustering, association, and dimensionality. Clustering is a data mining technique that groups unlabeled data based on similarities and differences. This technique is often used to process raw, unclassified data objects into groups represented by structures or patterns in the information. Association is a rule-based method for finding relationships between variables in a given dataset. This method is often used for market basket analysis. Dimensionality reduction is used when a given dataset's number of features (dimensions) is too high. This technique is commonly used in the preprocessing of data.

Variations of supervised and unsupervised training may also be employed. Semi-supervised learning is a technique in which the training dataset 710 includes a mix of labeled and unlabeled data of the same distribution. Incremental learning is a variant of supervised learning in which input data is continuously used to train the model further. Incremental learning enables the trained neural network 730 to adapt to the new data 740 without forgetting the knowledge instilled within the network during initial training.

Configurations of the present disclosure can be characterized by the following clauses:
1. A method used in running tubulars (10a, 10b), the method comprising: making up (310) a threaded connection (15) of the tubulars (10a, 10b) by applying torque in rotating at least one of the tubulars (10a, 10b) in turns with connection equipment (100) relative to another of the tubulars (10a, 10b); measuring (320), with sensors (140) associated with the connection equipment (100), data as measured data during makeup of the threaded connection (15); processing (330), with a control system (200), the measured data as processed data; generating (340), with the control system (200), a graphical representation (400, 410, 420, 430) of the processed data; analyzing (350), in analysis with an artificial intelligence model implemented in a computing environment (50), the graphical representation (400, 410, 420, 430) for at least one connection error indicative of a failed makeup of the threaded connection (15); and providing (360), with the control system (200), an output accepting or rejecting the threaded connection (15) based on the analysis (350).
2. The method of clause 1, wherein analyzing in the analysis with the artificial intelligence model implemented in the computing environment (50) comprises analyzing with the artificial intelligence model implemented on one or more of: the control system (200), a remote system (60), and a cloud-based system in the computing environment (50).
3. The method of clause 1 or 2, wherein: measuring (310) the data comprises measuring torque values applied to the threaded connection (15) and turns values of the at least one tubular (10a, 10b) being rotated; processing (330) the measured data comprises evaluating the torque values relative to the turns values; and generating (340), with the control system (200), the graphical representation (400, 410, 420, 430) of the processed data comprises graphing a torque-turns curve of the torque values relative to the turns values.
4. The method of clause 3, wherein analyzing (350), in the analysis with the artificial intelligence model, the graphical representation (400, 410, 420, 430) for the at least one connection error comprises: analyzing the torque-turn curve for the turns values relative to a minimum turns threshold; analyzing the torque-turn curve for the torque values relative to a minimum torque threshold; and determining, based on the analysis (350) of the torque-turns curve, a lack of connection being indicative of the at least one connection error.
5. The method of clause 3 or 4, wherein analyzing (350), in the analysis with the artificial intelligence model, the graphical representation (400, 410, 420, 430) for the at least one connection error comprises: analyzing the torque-turns curve for the torque values relative to a maximum torque threshold; and determining, based on the analysis (350) of the torque-turns curve, a torque spike being indicative of the at least one connection error.
6. The method of clause 3, 4 or 5, wherein analyzing (350), in the analysis with the artificial intelligence model, the graphical representation (400, 410, 420, 430) for the at least one connection error comprises determining, based on the analysis (350) of the torque-turns curve, a torque drop being indicative of the at least one connection error.
7. The method of any one of clauses 3 to 6, wherein analyzing, in the analysis with the artificial intelligence model, the graphical representation for the at least one connection error comprises:
analyzing the torque-turns curve for an indicated pattern; and
determining, based on the indicated pattern, an issue associated with at least one of the connection equipment and the threaded connection as the at least one connection error.
8. The method of claim 7, wherein: analyzing the torque-turns curve for the indicated pattern comprises analyzing the torque-turns curve for at least one of: an irregular pattern, a repeating pattern, and an oscillating pattern; and determining the issue comprises determining at least one of: an issue with misalignment between the tubulars, an issue with threading in the threaded connection, an issue with mechanics of the connection equipment, an issue with a gear in the connection equipment, an issue with hydraulics of the connection equipment, and an issue with disruptive movement of the connection equipment.
9. The method of any one of clauses 3 to 8, wherein analyzing, in the analysis with the artificial intelligence model, the graphical representation for the at least one connection error comprises: receiving a manual indication of a shouldering point in the threaded connection; evaluating the manual indication based on the analysis of the graphical representation with the artificial intelligence model; and determining, based on the evaluation of the manual indication, improper shouldering within the threaded connection as the at least one connection error.
10. The method of any one of clauses 3 to 9, wherein analyzing, in the analysis with the artificial intelligence model, the graphical representation for the at least one connection error comprises: analyzing the torque-turns curve; and determining a shouldering point in the threaded connection based on the analysis, optionally wherein providing the output comprises returning an indication of the shouldering point.
11. The method of clause 3 or 10, further comprising determining improper shouldering within the threaded connection; and wherein providing the output comprises returning an indication of the improper shouldering as the at least one connection error, optionally wherein determining the improper shouldering comprises determining a deviation, a hump, a drop, a low shouldering point, a high shouldering point, or an irregular shape in the torque-turns curve.
12. The method of any one of clauses 1 to 11, wherein: measuring (320) the data comprises measuring time values and measuring torque values; processing (330) the measured data comprises evaluating the torque values over the time values; generating (340), with the control system (200), the graphical representation (400, 410, 420, 430) of the processed data comprises incorporating the torque values over the time values in the graphical representation (400, 410, 420, 430); and analyzing (350) the graphical representation (400, 410, 420, 430) comprises determining a decrease in the torque values over the time values being indicative of the at least one connection error.
13. The method of any one of clauses 1 to 12, wherein: measuring (320) the data comprises measuring torque values and measuring turns values; processing (330) the measured data comprises evaluating slope as the torque values per turn relative to the turns values; generating (340), with the control system (200), the graphical representation (400, 410, 420, 430) of the processed data comprises incorporating the slope relative to the turns values in the graphical representation (400, 410, 420, 430); and analyzing (350) the graphical representation (400, 410, 420, 430) comprises determining the at least one connection error based on the slope relative to the turns values.
14. The method of any one of clauses 1 to 13, wherein providing (360) the output comprises providing at least one of: a visual alarm to an operator, an audible alarm to the operator, a graphical user interface (530) to the operator, and an automated control to the connection equipment (100) to break the threaded connection (15).
15. The method of any one of clauses 1 to 14, wherein analyzing (350), in the analysis with the artificial intelligence model, the graphical representation (400, 410, 420, 430) for the at least one connection error comprises one of:
implementing the artificial intelligence model including a large language model trained by a dataset of training graphical representations; and analyzing graphical data in the graphical representation (400, 410, 420, 430) directly with the large language model for the at least one connection error;
implementing the artificial intelligence model including a large language model trained by a dataset of training graphical representations; converting graphical data in the graphical representation (400, 410, 420, 430) input into the large language model into an output of descriptive text; and analyzing the descriptive text with the artificial intelligence model for the at least one connection error; and
implementing the artificial intelligence model including a convolutional neural network (722) trained by a dataset of training graphical representations; and analyzing graphical data in the graphical representation (400, 410, 420, 430) directly with the convolutional neural network (722) for the at least one connection error.
16. A system used in running tubulars, the system comprising: connection equipment (100) operable to apply torque to rotate at least one of the tubulars (10a, 10b) in turns relative to the other of the tubulars (10a, 10b) during makeup of a threaded connection (15); sensors (140) associated with the connection equipment and being configured to measure data as measured during the makeup of the threaded connection; a control system (200) operably connected to the connection equipment (100) and in communication with the sensors (140), wherein the control system (200) is configured to perform a method according to any one of clauses 1 to 15.
17. A system used in running tubulars (10a, 10b), the system comprising: connection equipment (100) operable to apply torque to rotate at least one of the tubulars (10a, 10b) in turns relative to the other of the tubulars (10a, 10b) during makeup of a threaded connection (15); sensors (140) associated with the connection equipment (100) and being configured to measure data as measured during the makeup of the threaded connection (15); a control system (200) operably connected to the connection equipment (100) and in communication with the sensors (140), wherein the control system (200) is configured to: process (330) the measured data as processed data; generate (340) a graphical representation (400, 410, 420, 430) of the processed data; analyze (350), in an analysis with an artificial intelligence model implemented on the control system (200), the graphical representation (400, 410, 420, 430) for at least one connection error indicative of a failed makeup of the threaded connection (15); and provide (360) an output accepting or rejecting the threaded connection (15) based on the analysis (350).
18. The system of clause 16 or 17, wherein the sensors (140) comprise: a torque cell being configured to measure the torque applied to the threaded connection (15); a turns counter (146, 148, 158) being configured to measure the turns of the at least one tubular (10a, 10b) being rotated; and a timer (205) being configured to measure time.
19. The system of any one of clauses 16, 17, or 18, wherein the control system (200) comprises: a programmable logic controller (202) in communication with the connection equipment (100) and the sensors (140) and including a program to automatically make up the threaded connection (15); and a computer in communication with the programmable logic controller (202) and having a program to automatically analyze the threaded connection (15).

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A method used in running tubulars, the method comprising:
making up a threaded connection of the tubulars by applying torque in rotating at least one of the tubulars in turns with connection equipment relative to another of the tubulars;
measuring, with sensors associated with the connection equipment, data as measured data during makeup of the threaded connection;
processing, with a control system, the measured data as processed data;
generating, with the control system, a graphical representation of the processed data;
analyzing, in analysis with an artificial intelligence model implemented in a computing environment, the graphical representation for at least one connection error indicative of a failed makeup of the threaded connection; and
providing, with the control system, an output accepting or rejecting the threaded connection based on the analysis.

2. The method of claim 1, wherein analyzing in the analysis with the artificial intelligence model implemented in the computing environment comprises analyzing with the artificial intelligence model implemented on one or more of: the control system, a remote system, and a cloud-based system in the computing environment.

3. The method of claim 1, wherein:
measuring the data comprises measuring torque values applied to the threaded connection and turns values of the at least one tubular being rotated;
processing the measured data comprises evaluating the torque values relative to the turns values; and
generating, with the control system, the graphical representation of the processed data comprises graphing a torque-turns curve of the torque values relative to the turns values.

4. The method of claim 3, wherein analyzing, in the analysis with the artificial intelligence model, the graphical representation for the at least one connection error comprises:
analyzing the torque-turn curve for the turns values relative to a minimum turns threshold;
analyzing the torque-turn curve for the torque values relative to a minimum torque threshold; and
determining, based on the analysis of the torque-turns curve, a lack of connection being indicative of the at least one connection error.

5. The method of claim 3, wherein analyzing, in the analysis with the artificial intelligence model, the graphical representation for the at least one connection error comprises:
analyzing the torque-turns curve for the torque values relative to a maximum torque threshold; and
determining, based on the analysis of the torque-turns curve, a torque spike being indicative of the at least one connection error.

6. The method of claim 3, wherein analyzing, in the analysis with the artificial intelligence model, the graphical representation for the at least one connection error comprises determining, based on the analysis of the torque-turns curve, a torque drop being indicative of the at least one connection error.

7. The method of claim 3, wherein analyzing, in the analysis with the artificial intelligence model, the graphical representation for the at least one connection error comprises:
analyzing the torque-turns curve for an indicated pattern; and
determining, based on the indicated pattern, an issue associated with at least one of the connection equipment and the threaded connection as the at least one connection error.

8. The method of claim 7, wherein:
analyzing the torque-turns curve for the indicated pattern comprises analyzing the torque-turns curve for at least one of: an irregular pattern, a repeating pattern, and an oscillating pattern; and
determining the issue comprises determining at least one of: an issue with misalignment between the tubulars, an issue with threading in the threaded connection, an issue with mechanics of the connection equipment, an issue with a gear in the connection equipment, an issue with hydraulics of the connection equipment, and an issue with disruptive movement of the connection equipment.

9. The method of claim 3, wherein analyzing, in the analysis with the artificial intelligence model, the graphical representation for the at least one connection error comprises:
receiving a manual indication of a shouldering point in the threaded connection;
evaluating the manual indication based on the analysis of the graphical representation with the artificial intelligence model; and
determining, based on the evaluation of the manual indication, improper shouldering within the threaded connection as the at least one connection error.

10. The method of claim 3, wherein analyzing, in the analysis with the artificial intelligence model, the graphical representation for the at least one connection error comprises:
analyzing the torque-turns curve; and
determining a shouldering point in the threaded connection based on the analysis.

11. The method of claim 10, wherein providing the output comprises returning an indication of the shouldering point.

12. The method of claim 3, further comprising determining improper shouldering within the threaded connection; and wherein providing the output comprises returning an indication of the improper shouldering as the at least one connection error.

13. The method of claim 12, wherein determining the improper shouldering comprises determining a deviation, a hump, a drop, a low shouldering point, a high shouldering point, or an irregular shape in the torque-turns curve.

14. The method of claim 1, wherein:
measuring the data comprises measuring time values and measuring torque values;
processing the measured data comprises evaluating the torque values over the time values;
generating, with the control system, the graphical representation of the processed data comprises incorporating the torque values over the time values in the graphical representation; and
analyzing the graphical representation comprises determining a decrease in the torque values over the time values being indicative of the at least one connection error.

15. The method of claim 1, wherein:
measuring the data comprises measuring torque values and measuring turns values;
processing the measured data comprises evaluating slope as the torque values per turn relative to the turns values;
generating, with the control system, the graphical representation of the processed data comprises incorporating the slope relative to the turns values in the graphical representation; and
analyzing the graphical representation comprises determining the at least one connection error based on the slope relative to the turns values.

16. The method of claim 1, wherein providing the output comprises providing at least one of: a visual alarm to an operator, an audible alarm to the operator, a graphical user interface to the operator, and an automated control to the connection equipment to break the threaded connection.

17. The method of claim 1, wherein analyzing, in the analysis with the artificial intelligence model, the graphical representation for the at least one connection error comprises:
implementing the artificial intelligence model including a large language model trained by a dataset of training graphical representations; and
analyzing graphical data in the graphical representation directly with the large language model for the at least one connection error.

18. The method of claim 1, wherein analyzing, in the analysis with the artificial intelligence model, the graphical representation for the at least one connection error comprises:
implementing the artificial intelligence model including a large language model trained by a dataset of training graphical representations;
converting graphical data in the graphical representation input into the large language model into an output of descriptive text; and
analyzing the descriptive text with the artificial intelligence model or keyword search for the at least one connection error.

19. The method of claim 1, wherein analyzing, in the analysis with the artificial intelligence model, the graphical representation for the at least one connection error comprises:
implementing the artificial intelligence model including a convolutional neural network trained by a dataset of training graphical representations; and
analyzing graphical data in the graphical representation directly with the convolutional neural network for the at least one connection error.

20. A method used in running tubulars, the method comprising:
making up threaded connections of the tubulars by applying torque in rotating at least one of the tubulars in turns with connection equipment relative to another of the tubulars;
measuring, with sensors associated with the connection equipment, data as measured data during makeup of the threaded connections;
processing, with a control system, the measured data as processed data;
generating, with the control system, graphical representations of the processed data;
receiving, with the control system, assessments of initial ones of the threaded connections, the assessments being user-indicated and being based on at least one connection error indicative of a failed makeup;
training an artificial intelligence model implemented on the control system with the graphical representations based on the assessments;
analyzing, in an analysis with the trained artificial intelligence model implemented on the control system, subsequent ones of the graphical representations for the at least one connection error; and
providing, with the control system, outputs indicative of the subsequent threaded connections based on the analysis.

21. The method of claim 20, further comprising:
receiving, with the control system, choices of the outputs, the choices being user-indicated and confirming and declining the acceptance and the rejections of the subsequent threaded connections; and
training the artificial intelligence model implemented on the control system with the graphical representations based on the choices.

22. A system used in running tubulars, the system comprising:
connection equipment operable to apply torque to rotate at least one of the tubulars in turns relative to the other of the tubulars during makeup of a threaded connection;
sensors associated with the connection equipment and being configured to measure data as measured during the makeup of the threaded connection;
a control system operably connected to the connection equipment and in communication with the sensors, wherein the control system is configured to:
process the measured data as processed data;
generate a graphical representation of the processed data;
analyze, in an analysis with an artificial intelligence model implemented on the control system, the graphical representation for at least one connection error indicative of a failed makeup of the threaded connection; and
provide an output accepting or rejecting the threaded connection based on the analysis.

23. The system of claim 22, wherein the sensors comprise:
a torque cell being configured to measure the torque applied to the threaded connection;
a turns counter being configured to measure the turns of the at least one tubular being rotated; and
a timer being configured to measure time.

24. The system of claim 22, wherein the control system comprises:
a programmable logic controller in communication with the connection equipment and the sensors and including a program to automatically make up the threaded connection; and
a computer in communication with the programmable logic controller and having a program to automatically analyze the threaded connection.
